(19) United States
(12) Patent Application Publication
(10) Pub. No.: US 2008/0092958 A1
(43) Pub. Date: Apr. 24, 2008

(54) DownSpout WaterSaver

(76) Inventor: Thomas Edward Dwyer, Shrewsbury, PA (US)

Correspondence Address: THOMAS EDWARD DWYER, 229 FAIRMOUNT COURT, SHREWSBURY, PA, 17361, US

(21) Appl. No.: 11/585,031

(22) Filed: Oct. 24, 2006

(51) Int. Cl. G05D 11/00

(52) U.S. Cl. 137/118.01

(57) ABSTRACT

Nearly all residential and commercial buildings in the United States contain systems for the collection, flow, and run off of rainwater and condensation. Most of that water is funneled into existing municipal drainage systems or simply diverted onto the adjoining ground, but away from the building structure. This invention adds to that system a means to capture and store some of that water. It is intended primarily for residential use, but could be used in commercial applications as well. The invention interrupts the flow of water traveling through the down spout and diverts a preset amount into a storage tank. An exit back into the existing down spout carries all water back into the drainage system over and above that stored in the tank. It contains a flow control system that can be set to force all water through the normal drainage system, this is primarily for cold weather climates where freezing would be a concern in the storage tank.

It is intended to be constructed of the same materials that are commonly used in current down spout water drainage systems. This would allow for the invention to be esthetically pleasing to homeowners/building owners. The storage tank would range in size depending on the amount of water desired to be stored and the available space for installation.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCES CITED

Not Applicable

### BACKGROUND OF THE INVENTION

Watering plants and vegetables in the immediate vicinity of our home required carrying a water container into the house; often several trips were involved. I had the idea to make this task easier to accomplish by capturing and storing the water in my down spouts. These are located at the corners of my home and easily accessible to the deck and flowerbeds. I realized that such a system would also make use of rainwater just flushing away from the house, a resource currently being wasted. While one homeowner may only save several hundred gallons of water annually, if many people use this system, an enormous amount of water use would be removed from the nations potable water supply.

### BRIEF SUMMARY OF THE INVENTION

The DownSpout WaterSaver is a device for capturing and storing rainwater. It is designed to connect into any down spout system. The primary purpose for the DownSpout WaterSaver's creation was to capture and store rainwater for uses around a home, such as watering plants around homes and decks.

### BRIEF DESCRIPTION OF THE DRAWINGS

FIG. 1 is a perspective view of the DownSpout WaterSaver highlighting the main points of the invention;

FIG. 2 is a left side elevation view of the invention;

FIG. 3 is a right side elevation view of the invention;

FIG. 4 is a cross-sectional view of the invention taken through the line 1-1 of FIG. 2;

FIG. 5 is a fragmentary side view of the water flow control system described in claim 2, referencing the integral parts of the system and showing the flow of water during the stage that captures the collected water.

FIG. 6 is a fragmentary front view of the water flow control system described in claim 2, referencing the integral parts of the system.

FIG. 7 is a fragmentary side view of the water flow control system described in claim 2, referencing the integral parts of the system and showing the flow of water during the cold weather stage that bypasses capturing the collected water and allows it to continue flowing through the original down spout and out to normal discharge.

FIG. 8 is a fragmentary rear view of the water flow control system described in claim 2, referencing the integral parts of the system.

FIG. 9 is a fragmentary side view of the alternate water flow control system described in claim 3, referencing the integral parts of the system and showing the optional flow of water during the stage that captures the collected water.

FIG. 10 is a fragmentary front view of the alternate water optional flow control system described in claim 3, referencing the integral parts of the system.

FIG. 11 is a fragmentary side view of the alternate water flow control system described in claim 3, referencing the integral parts of the system and showing the flow of water during the cold weather stage that bypasses capturing the collected water and allows it to continue flowing through the original down spout and out to normal discharge.

FIG. 12 is a fragmentary rear view of the alternate water flow control system described in claim 3, referencing the integral parts of the system.

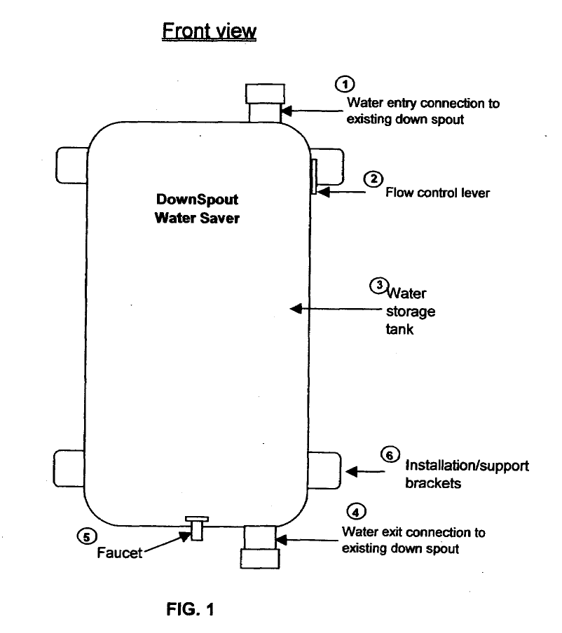

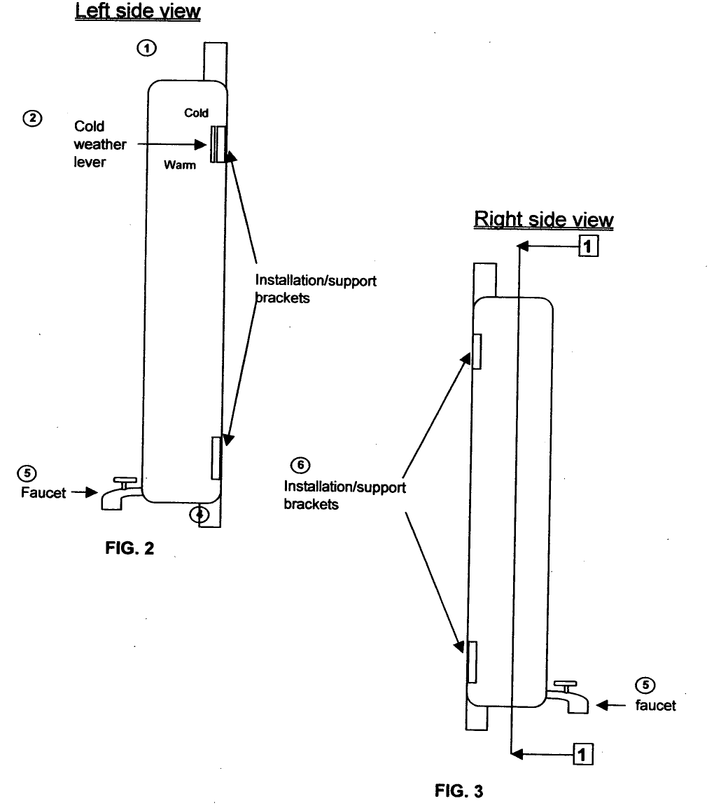

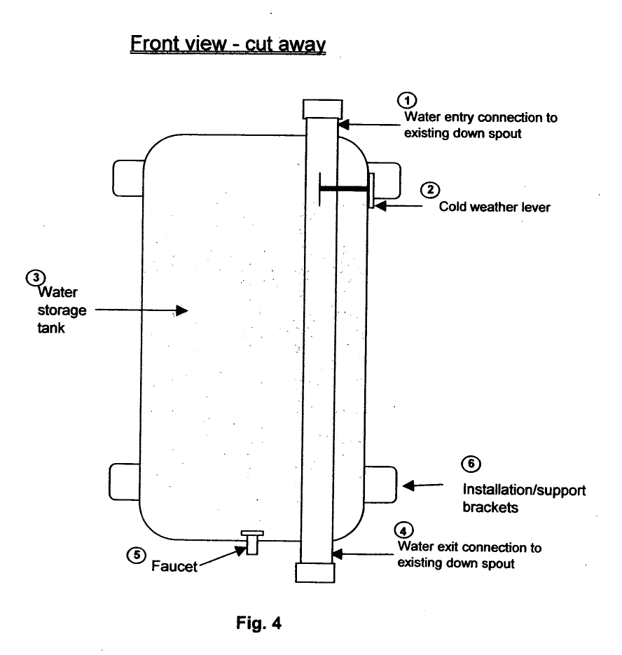

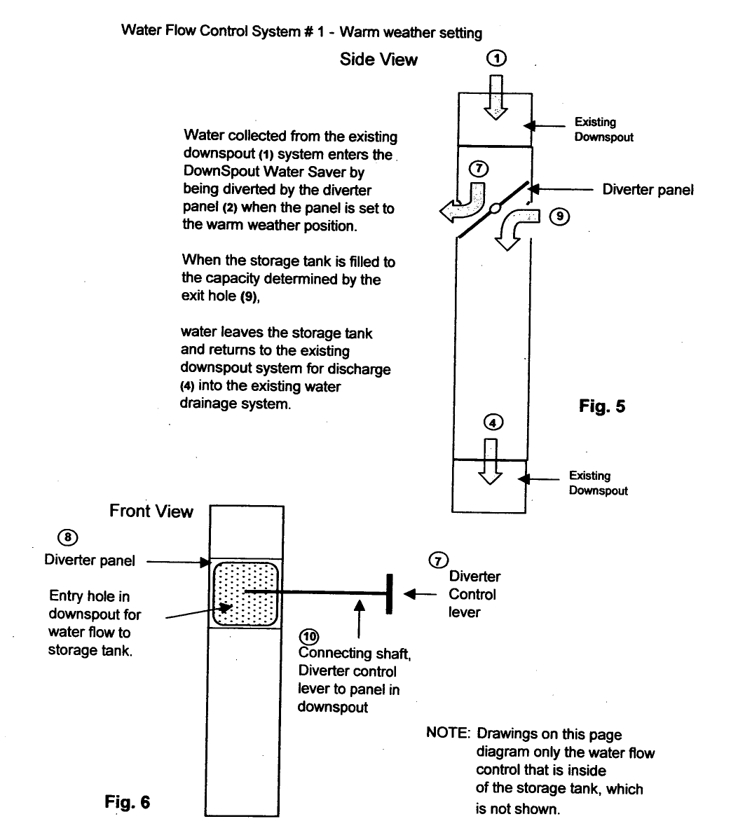

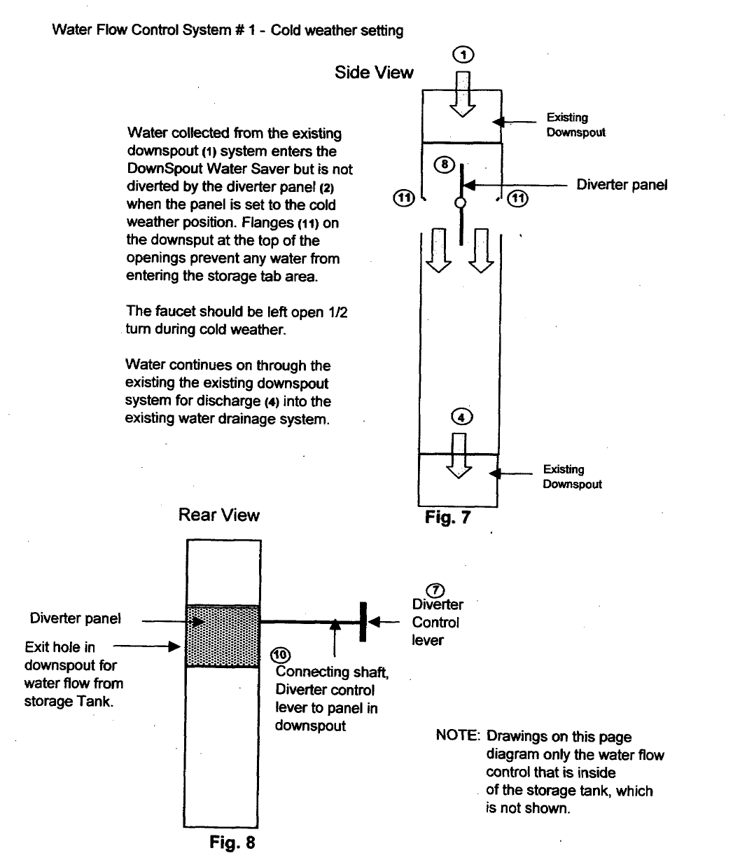

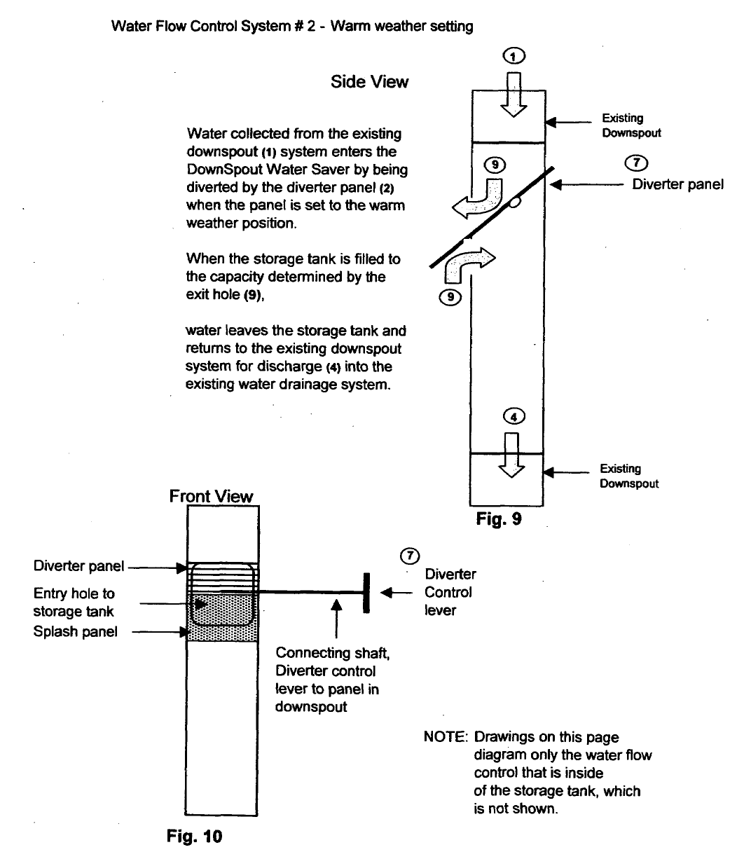

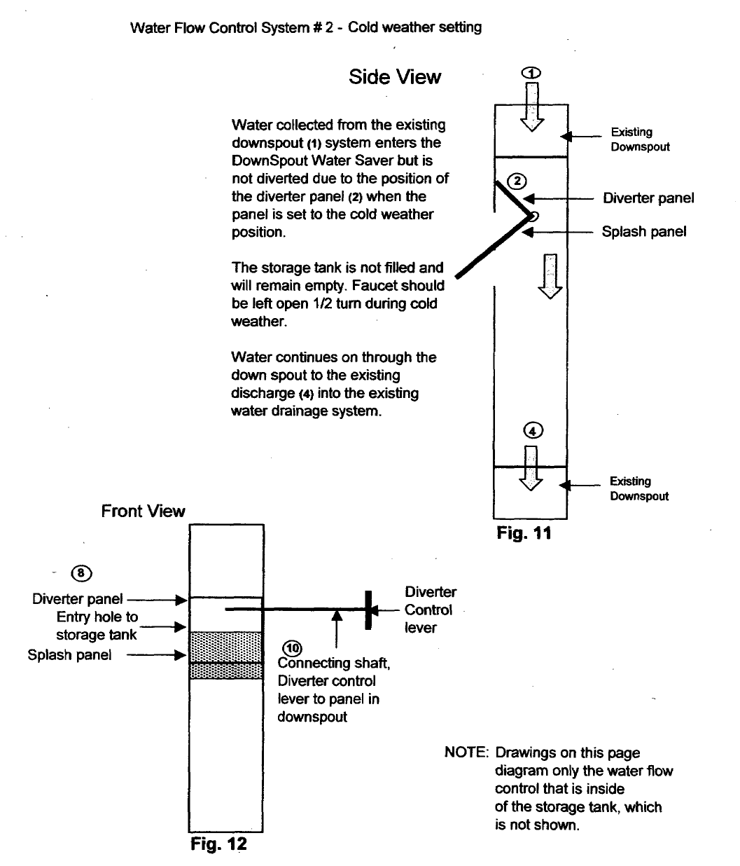

### DETAILED DESCRIPTION OF THE INVENTION

### Detailed Description:

The DownSpout WaterSaver consists of an intake connection (1) for attaching to the existing down spout, a storage tank (3) for holding the collected rain water, a faucet (5) for drawing off the collected water, a water flow control valve (2) and an out going connection (4) for attaching to the exiting down spout to carry over flow back into the existing system.

The water flow control valve (2) is used to control water flow during cold weather in cold weather climates. Setting the valve (2) in one direction will force the flow to remain entirely in the existing down spout system and not allow water into the storage area. The storage tank (3) will have to be drained by opening the faucet and leaving it in an open position during cold weather. Setting the valve (2) in the second position will divert water into the storage tank (3) until the tank (3) reaches it's capacity, at which time any over capacity water will exit the tank (4) and return to the existing down spout system.

It has support brackets (6) for securing the WaterSaver to the existing building or structure.

The WaterSaver is an environmentally friendly device in that it collects and makes use of rainwater, thereby relieving some portion of the use on home and municipal water systems.

It's primary design purpose is for home owners to collect and store rain water for domestic uses that do not require potable water.

It is designed to be constructed in varying sizes to match the end user's needs. It can be constructed of the same materials as is used in current down spout systems.

The storage tank (3) can be various sizes depending on the amount of rainwater that is desired to be stored and the available space for installation of the system.

### Manner and Process for use of the System

The DownSpout WaterSaver is designed to be connected to an existing down spout by removing a specified portion of the existing system. The portion removed will depend on the size of the storage tank used. The DownSpout WaterSaver has connections for both ends of the down spout left when the installed portion was removed. It also has additional connections to secure the tank to the existing structure. Reference WaterSaver drawings.

It is the intention of the inventor to license the manufacture and sale of the DownSpout WaterSaver to existing current manufacturers of down spouts and gutters. It is intended that the system will be manufactured from the same materials as is currently used in the building industry. This will allow for the Water Saver to be “matched” to the existing structure for aesthetic purposes. This can be either by the color match of the existing materials or by painting to a matching/contrasting color.

It is designed primarily for homeowners to capture, store and use rain water for non-potable purposes. Some of which are:
1. Watering plants and flowers. It could be installed at all areas of the home where down spouts currently exist. The spigot allows connecting standard hoses if desired, or the water could simply be drawn off into watering cans.
2. Home owners could use it for storing emergency water for non-potable water use during an emergency that prevents them from using the normal water system. This water could be used to flush toilets, etc.

What is claimed:

1. A water collection and storage system comprising:
connectors which allow installation into down spout water systems, a storage tank, a spigot for drawing off the supply of stored water, a water flow control valve to control the flow of water into and out of the storage tank and mounting brackets for installation onto a building structure,
said collection and storage system being constructed of materials commonly used in down spout systems in the building industry.

2. A water flow control system consisting of a control lever, diverter panel, connecting shaft and entry/exit holes, which divert collected down spout water into a storage tank allowing for automatic overflow back into the existing down spout water system, or bypasses the storage system and allows water to flow continually through the existing down spout system.

3. An alternative flow control system consisting of a “V” shaped hinged diverter panel, connecting shaft, splash panel and entry/exit holes which diverts collected water into a storage tank allowing for automatic overflow back into the existing water system, or bypasses the storage system and allows water to flow continually through the existing down spout system.
